(19) United States
(12) Patent Application Publication
(10) Pub. No.: US 2021/0339916 A1
(43) Pub. Date: Nov. 4, 2021

(54) PASTE TUBE DISPENSER WITH A SEALING BODY AND METHODS OF MAKING AND USING SAME

(71) Applicant: Jinwoo Jang, Glen Ellyn, IL (US)

(72) Inventor: Jinwoo Jang, Glen Ellyn, IL (US)

(21) Appl. No.: 17/246,719

(22) Filed: May 3, 2021

Related U.S. Application Data
(60) Provisional application No. 63/019,157, filed on May 1, 2020.

(51) Int. Cl. B65D 35/24; C09J 7/38

(52) U.S. Cl. CPC B65D 35/247; C09J 7/381

(57) ABSTRACT

The present disclosure provides a tube dispenser (e.g., a paste tube dispenser) including a sealing body, and methods of making and using same.

### PRIORITY CLAIM

This application claims priority to U.S. Provisional Patent Application Ser. No. 63/019,157, filed May 1, 2020, the entire contents of which are incorporated herein by reference and relied on.

### FIELD

The present disclosure provides a tube dispenser (e.g., a paste tube dispenser) including a sealing body, and methods of making and using same.

### BACKGROUND

Tube dispensers, especially those for dispensing many doses of small amounts of material over a long period of time, are prone to creating mess and leaving substantial amounts of unused and inaccessible material in the tube dispenser.

A need persists for paste tube dispensers that enable convenient and substantially complete dispensing of paste therefrom.

### SUMMARY

The present disclosure provides tube dispenser (e.g., a paste tube dispenser) including a sealing body, and methods of making and using same.

One object of the present disclosure is to provide a paste tube dispenser with a sealing body for the paste tube to be easy to use. Generally, paste tubes consistent with the present disclosure may be squeezed at different parts of the sealing body to yield a non-uniformly deformed (e.g., closed or collapsed) shape, reducing effort required evacuate the paste from the paste tube dispenser over the duration of its use.

Another object of the present disclosure is to provide a paste tube dispenser with a sealing body that progressively seals from the bottom of the sealing body to the middle of the sealing body and finally to the upper portion of the sealing body to reduce mess associated with evacuating paste from the tube.

Another object of the present disclosure is to provide a paste tube dispenser with a sealing body that maintains its shape by retaining included paste substantially only in open portions of the sealing body with substantially little or no paste present in already-squeezed portions of the sealing body. As a result, squeezing all or substantially all paste from the tube is relatively easier using paste tube dispensers consistent with the present disclosure compared to conventional paste tubes.

In some embodiments, the present disclosure provides a paste tube dispenser including an outer surface, an inner surface disposed opposite the outer surface, and an outlet disposed at one end, the paste tube dispenser comprising: a first pressure sensitive adhesive disposed on a first portion of the inner surface; and a second pressure sensitive adhesive disposed on a second portion of the inner surface substantially opposite the first pressure sensitive adhesive, wherein upon squeezing the first pressure sensitive adhesive into contact with the second pressure sensitive adhesive, the first portion of the inner surface and the second portion of the inner surface collapse together to form a collapsed portion of the paste tube dispenser.

In other embodiments, the present disclosure provides a multilayer film for forming a progressively sealable paste tube dispenser, the multilayer laminate film comprising: an outermost layer; a pressure sensitive adhesive layer disposed opposite the outermost layer; an insulating layer disposed between the outermost layer and the pressure sensitive layer; a first bonding layer disposed between the outermost layer and the insulating layer; and a second bonding layer disposed between the pressure sensitive adhesive layer and the insulating layer.

In other embodiments, the present disclosure provides a multilayer film for forming a progressively sealable paste tube dispenser, the multilayer laminate film comprising: an outermost layer; a pressure sensitive adhesive layer disposed opposite the outermost layer; an aluminum layer disposed between the outermost layer and the pressure sensitive adhesive layer; a first copolymer layer disposed between the outermost layer and the aluminum layer; and a second copolymer layer disposed between the pressure sensitive adhesive layer and the aluminum layer.

In other embodiments, the present disclosure provides a method of making a progressively sealable paste tube dispenser, the method comprising: providing a multilayer film comprising at least an outermost layer and an inner layer disposed opposite the outermost layer; adhering to the inner layer a pressure sensitive adhesive layer to form a modified multilayer film; forming an open-ended tube having a generally cylindrical shape from the modified multilayer film; cutting the open-ended tube into a plurality of discrete open-ended cylindrical tube pre-forms; sealing a first end of the open-ended tube pre-forms to form an open-ended container; and forming a paste dispenser end opposite the first end to form the progressively sealable paste tube dispenser.

These and other embodiments are described in greater detail below with respect to the accompanying figures.

### BRIEF DESCRIPTION OF THE FIGURES

FIG. 1 shows a front cross-sectional view of a tube dispenser consistent with one embodiment of the present disclosure.

FIG. 2 shows a side perspective view of the tube dispenser of FIG. 1.

FIG. 3 shows a top plan view of the tube dispenser of FIG. 1.

FIG. 4 shows a side cross-sectional view of a tube dispenser consistent with the present disclosure before being squeezed.

FIG. 5 shows a side cross-sectional view of the tube dispenser of FIG. 4 after a first portion of the tube has been squeezed.

FIG. 6 shows a side cross-sectional view of the tube dispenser of FIG. 4 after a second portion of the tube has been squeezed.

FIG. 7 shows a side cross-sectional view of the tube dispenser of FIG. 4 after a third portion of the tube has been squeezed.

FIG. 8 shows a top plan view of a tube dispenser consistent with another embodiment of the present disclosure.

FIG. 9 shows a top plan view of a tube dispenser consistent with another embodiment of the present disclosure.

FIG. 10 shows a top plan view of a tube dispenser consistent with another embodiment of the present disclosure.

FIG. 11 shows a schematic representation of a method of forming a tube dispenser consistent with one embodiment of the present disclosure.

FIG. 12 shows a multilayer film for forming a progressively sealable paste tube dispenser consistent with one embodiment of the present disclosure.

FIG. 13 shows a multilayer film for forming a progressively sealable paste tube dispenser consistent with another embodiment of the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

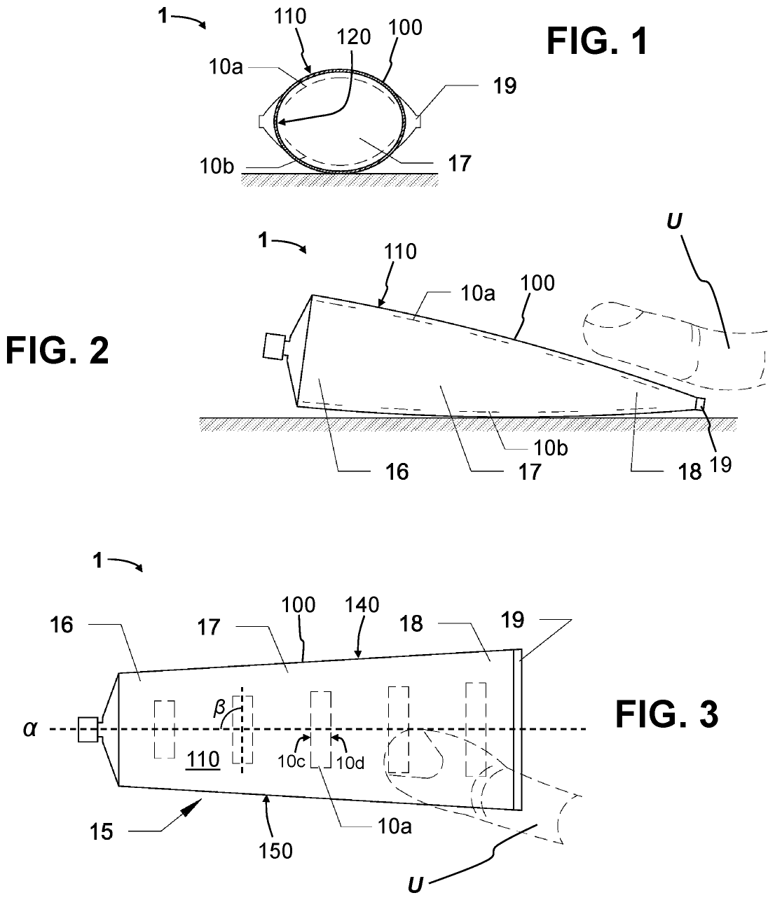

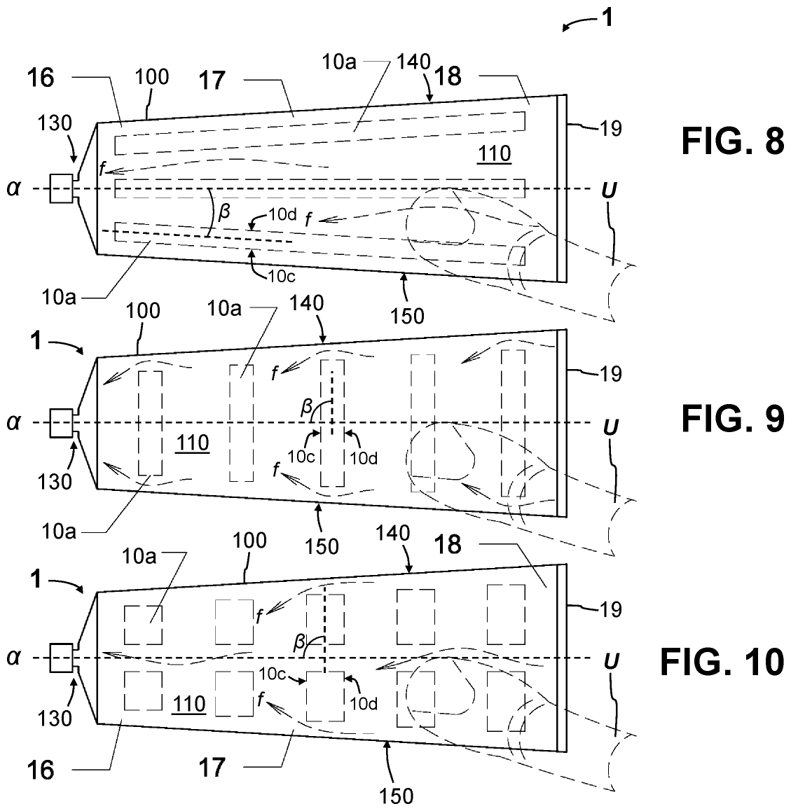

Referring generally to FIGS. 1-13, the present disclosure provides a tube dispenser 1 (e.g., a paste tube dispenser) including a sealing body 100 and an outlet 130, and methods of making and using same.

### Progressively Sealable Tubes

In general, the sealing body 100 includes an outside surface 110, an inside surface 120 disposed opposite the outside surface 110, a sealed end 19, and an outlet 130 disposed generally opposite the sealed end 19. The sealing body 100 is partially defined by a longitudinal axis α that extends generally from the sealed end 19 through the opening 130.

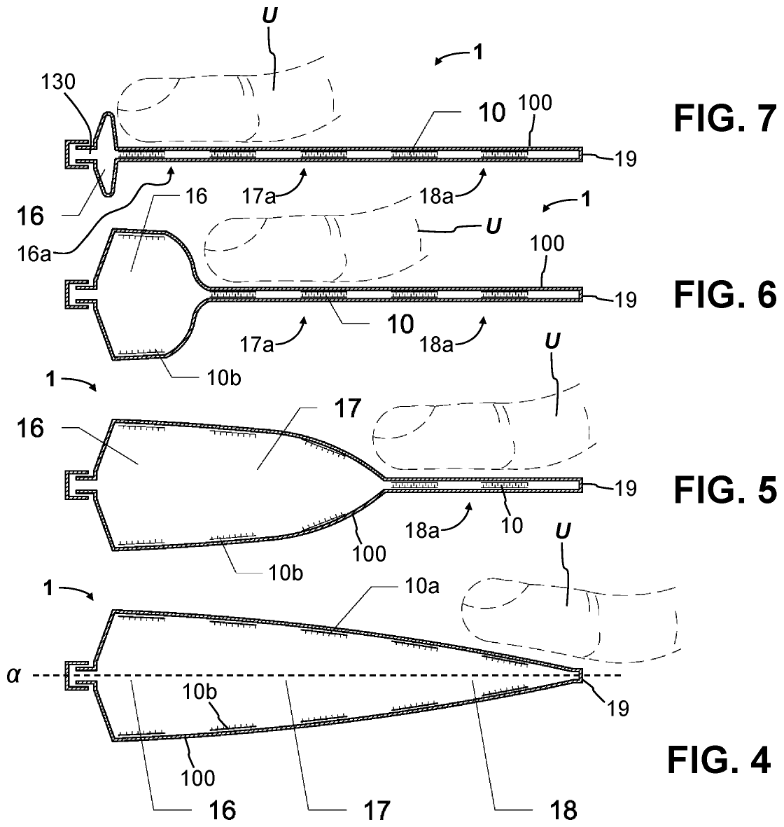

The sealing body 100 may comprise one or more zones 16-18. For example and without limitation, the sealing body 100 of the embodiments specifically illustrated in FIGS. 2-10 includes a first zone 16 proximal to the outlet 130, a third zone 18 proximal to the sealed end 19, and a second zone 17 disposed generally between the first zone 16 and the third zone 18. The zones 16-18 are labeled to provide clarity on the operation of the tube dispensers 1 disclosed herein. Accordingly, the absolute number of zones 16-18 may vary from embodiment to embodiment. Each zone 16-18 may include more than one pair of pressure sensitive adhesive portions 10a-10b. For example and without limitation, the embodiment specifically illustrated in FIGS. 4-7 include two pairs of pressure sensitive adhesives 10a-10b for each zone 16-18.

Pressure sensitive adhesive 10a-10b is disposed on the inside surface 120 of the sealing body 100. As shown representatively in FIGS. 4-7, the pressure sensitive adhesive 10a-10b is configured to cause individual zones 16-18 of the sealing body 100 to retain a closed or collapsed configuration after a user U squeezes material out of the individual zones 16-18 towards the outlet 130. Once in a closed or collapsed configuration, paste in the remaining zones 15-18 is more easily forced towards the outlet 130; the configuration of the closed or collapsed zones 15-18 towards the sealed end 19 of the sealing body 100 provides a barrier for paste to return to already-evacuated zones. In this manner, tube dispensers 1 consistent with the present disclosure reduce waste by enabling convenient evacuation of all or substantially all paste from the tube dispenser 1 compared to known tube dispensers.

Referring again generally to FIGS. 4-7, a first portion of the pressure sensitive adhesive 10a mates with a second portion of the pressure sensitive adhesive 10b disposed generally opposite the first portion 10a when the user U squeezes the sealing body 100 into a closed or collapsed configuration.

In some embodiments, the closed or collapsed zones are configured to return to an open configuration by, for example, squeezing on opposing lateral edges 140-150 of the sealing body 100 proximal to the mated pressure sensitive adhesive portions 10.

Paste tube dispensers 1 consistent with the present disclosure may be progressively sealed from the sealed end 19 towards the outlet 130 as paste is evacuated from the paste tube dispenser 1 by the user U. For example and without limitation, the user U may first evacuate paste from the paste tube dispenser 1 by squeezing the outer surface 110 of the sealing body 100 near the sealed end 19. As the first pressure sensitive adhesive 10a comes into contact with the second pressure sensitive adhesive 10b disposed on the inner surface 120 generally opposite the first sensitive adhesive 10a, the pressure sensitive adhesive portions 10a-10b mate to form a mated pair of pressure sensitive adhesives 10 in the third collapsed zone 18a of the sealing tube 100. As additional pressure is placed on the outer surface 110 by the user U, paste continued to flow in a direction f through the remaining open zones 16-17 and towards the outlet 130. Eventually, pressure applied by the user U on the outer surface 110 forces pressure sensitive adhesive pairs 10a-10b in the second zone 17 to mate, forming a second mated pair of pressure sensitive adhesives 10 and resulting in a second collapsed zone 17a. As additional pressure is placed on the outer surface 110 by the user U, paste continued to flow in a direction f through the remaining open zone 16 and towards the outlet 130. Eventually, additional pressure applied by the user U on the outer surface 110 forces pressure sensitive adhesive pairs 10a-10b in the first zone 16 to mate, forming a third mated pair of pressure sensitive adhesives 10 and resulting in a third collapsed zone 16a.

In some embodiments, the pressure sensitive adhesive portions 10a-10b are segments (e.g., strips) of pressure sensitive adhesive material disposed on discrete areas of the inner surface 120. In some embodiments, the segments are disposed at an angle β relative to the axis α of the sealing body 100. In some embodiments, the angle β is acute. In other embodiments, the angle β is obtuse. In still other embodiments, the angle β is about 90° (e.g., generally right). As used herein, the angle β is generally determined as the measurement between the axis α of the sealing tube 100 and an axis γ of the segments of pressure sensitive adhesive material 10a-10b, wherein the axis γ is determined as the bisect of the angles formed between the longest two edges 10c-10d of the segments of pressure sensitive adhesive material 10a-10b.

In some embodiments, the pressure sensitive adhesive 10a-10b is hook-and-loop fastener, such as VELCRO hook-and-loop fastener. In some embodiments, the pressure sensitive adhesive 10a-10b is mushroom-head/mushroom-hook fastener, such as 3M Dual-Lock fastener. In some embodiments, the pressure sensitive adhesive 10a-10b is mixed hook-and-loop fastener, such as Halco USA mixed hook-and-loop fastener tape. In some embodiments, the pressure sensitive adhesive 10a-10b is a chemical-based pressure sensitive adhesive, such as a combination of an elastomeric compound (e.g., an acrylic, butyl rubber, ethylene-vinyl acetate with high vinyl acetate content, natural rubber, nitriles, silicone rubbers, etc.) and a tackifier (e.g., silicate resins such as trimethyl silane reacted with silicon tetrachloride), or a styrene block copolymer. For example and without limitation, the chemical-based pressure sensitive adhesive may comprise, consist essentially of, or consist of the rubberized waterproof adhesive used as a component of Flex Tape; or the polymer-based adhesive used as a component of Gorilla Tape.

When the contents of the tube (e.g., to be squeezed out of the opening) are for internal human use, such as toothpaste, the pressure sensitive adhesive 10a-10b is food-safe or designated Generally Regarded as Safe (“GRAS”) by the appropriate regulatory agency (e.g., the U.S. Food & Drug Administration). When the contents of the tube are for medical use, the pressure sensitive adhesive 10a-10b may be any suitable adhesive that (i) does not induce a chemical change (e.g., isomerization or degradation) of any active ingredient in the contents, and (ii) does not leach any unapproved active or inactive ingredient into the contents beyond a maximum daily exposure (MDE) level.

### Methods of Making Progressively Sealable Tubes

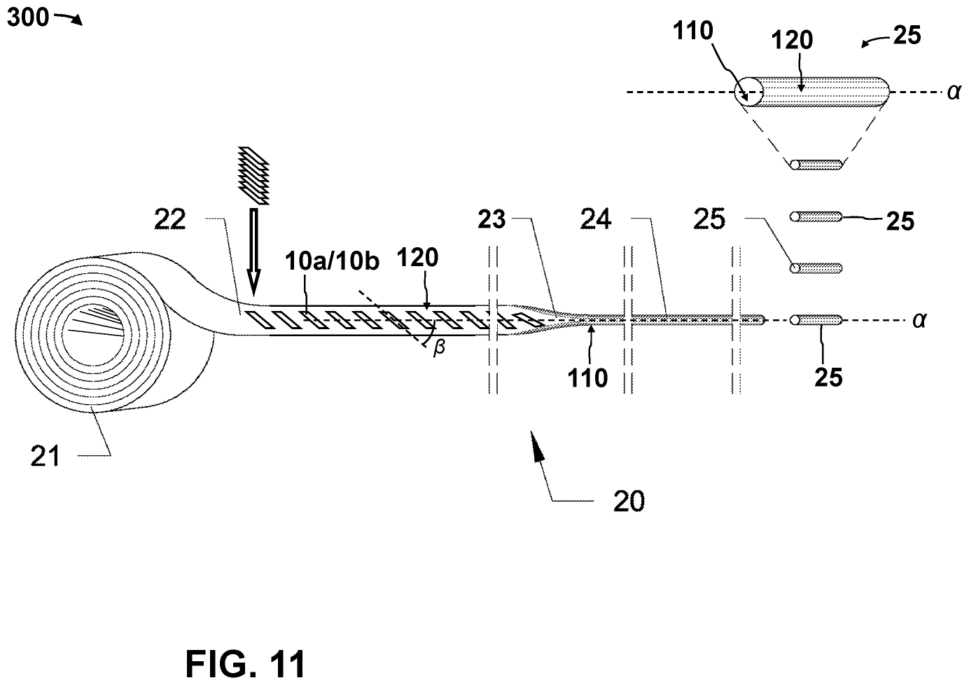

The present disclosure provides methods of making progressively sealable tubes 1 consistent with the present disclosure. In one embodiment representatively illustrated in FIG. 11, the method 300 comprises a step 23 of rolling a length of material 21 around its longitudinal axis α to form an elongated open-ended tube including an outer surface 110 and an inner surface 120. The method 300 further comprises a step 24 of dividing (e.g., cutting) the elongated open-ended tube into a plurality of discrete open-ended cylindrical tube pre-forms 25. The open-ended cylindrical tube pre-forms 25 may then be sealed at one end 19 and filled with the desired contents (e.g., paste) before forming an outlet 130 opposite the sealed end 19.

In some embodiments, the length of material includes pressure sensitive adhesive 10a-10b on one face 120. In other embodiments, the method 300 includes a step 22 of applying pressure sensitive adhesive 10a-10b to one face 120 of the length of material 21 before the step 23 of rolling the length of material 21 around its longitudinal axis α.

### Multilayer Films for Forming Progressively Sealable Tubes

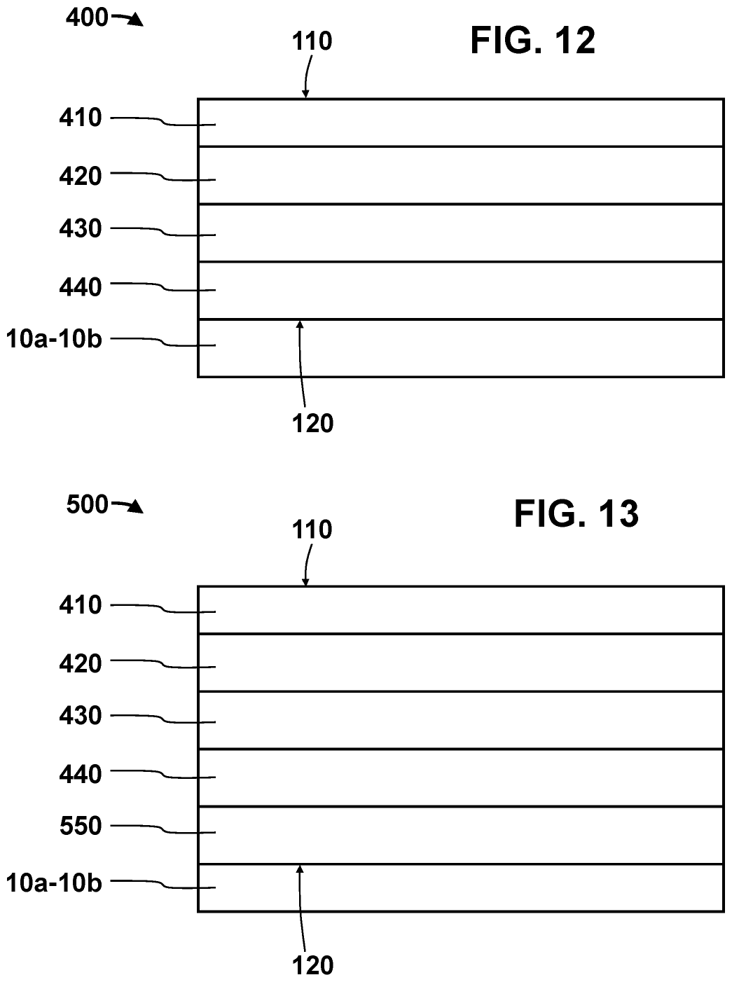

Referring now generally to FIGS. 12-13, the present disclosure provides multilayer films suitable for forming progressively sealable tubes 1 consistent with the present disclosure.

In some embodiments, the multilayer film 400 includes an outermost layer 410. The outermost layer 410 corresponds to the outer surface 110 of the sealed body 100 of tube dispensers 1 described herein. The outermost layer may comprise, consist essentially of, or consist of any suitable generally flexible or deformable material, such as polyethylene.

The multilayer film 400 further includes a pressure sensitive adhesive layer 10a-10b disposed opposite the outermost layer 410. The pressure sensitive adhesive layer 10a-10b corresponds to the pressure sensitive adhesive portions 10a-10b described herein, and may include any suitable pressure sensitive adhesive described above. The pressure sensitive adhesive layer 10a-10b may be a continuous layer in some embodiments. In other embodiments, the pressure sensitive adhesive layer 10a-10b includes discrete regions of pressure sensitive adhesive material 10a-10b separated by non-adhesive material (e.g., polyethylene). In still other embodiments, the pressure sensitive adhesive layer 10a-10b includes discrete regions of pressure sensitive adhesive material 10a-10b separated by null space (e.g., voids) such that the pressure sensitive adhesive layer 10a-10b does not form a smooth surface.

The multilayer film 400 further includes an insulating layer 430 disposed between the outermost layer 410 and the pressure sensitive adhesive layer 10a-10b. The insulating layer 430 may comprise, consist essentially of, or consist of any suitable material. In some embodiments, the insulating layer 430 comprises, consists essentially of, or consists of ethylene-vinyl alcohol copolymer (“EVOH”). In some embodiments, the insulating layer 430 comprises, consists essentially of, or consists of aluminum.

The multilayer film further includes a first bonding layer 420 disposed between the outermost layer 410 and the insulating layer 430, and a second bonding layer 440 disposed between the pressure sensitive adhesive layer 10a-10b and the insulating layer 430. The bonding layers 420, 440 may include any suitable bonding agent. In some embodiments, the bonding layers 420, 440 comprise, consist essentially of, or consist of a polyolefin-based tie-layer resin (e.g., ADMER Adhesive Resin, Mitsui Chemicals America, Inc.). In some embodiments, the bonding layers 420, 440 comprise, consist essentially of, or consist of a copolymer.

In some embodiments, a multilayer film 500 consistent with the present disclosure includes an outermost layer 410, a pressure sensitive adhesive layer 10a-10b disposed opposite the outermost layer 410, an insulating layer 430 disposed between the outermost layer 410 and the pressure sensitive adhesive layer 10a-10b, a first second bonding layer 420 disposed between the outermost layer 410 and the insulating layer 430, a second bonding layer 440 disposed between the pressure sensitive adhesive layer 10a-10b and the insulating layer 430, and an inner layer 550 disposed between the pressure sensitive adhesive layer 10a-10b and the insulating layer 430. In some such embodiments, the second bonding layer 440 is disposed between and directly in contact with the insulating layer 430 and the inner layer 550. The inner layer may comprise, consist essentially of, or consist of material(s) that is food-grade, GRAS, or that (i) does not induce a chemical change (e.g., isomerization or degradation) of any active ingredient in the contents, and (ii) does not leach any unapproved active or inactive ingredient into the contents beyond a maximum daily exposure (MDE) level. In some embodiments, the inner layer 550 comprises, consists essentially of, or consists of polyethylene.

In some embodiments, the multilayer film 500 further includes a third bonding layer (not shown) disposed between and directly in contact with the inner layer 550 and the pressure sensitive adhesive layer 10a-b.

In some embodiments, the multilayer film 400 consists essentially of a polyethylene outermost layer 410, a pressure sensitive adhesive layer 10a-10b disposed opposite the outermost layer 410, an EVOH insulating layer 430 disposed between the outermost layer 410 and the pressure sensitive adhesive layer 10a-10b, a first polyolefin-based tie-layer resin bonding layer 420 disposed between and directly in contact with the outermost layer 410 and the EVOH insulating layer 430, and a second polyolefin-based tie-layer resin bonding layer 440 disposed between and directly in contact with the EVOH insulating layer 430 and the pressure sensitive adhesive layer 10a-10b.

In some embodiments, the multilayer film 400 consists essentially of a polyethylene outermost layer 410, a pressure sensitive adhesive layer 10a-10b disposed opposite the outermost layer 410, an aluminum insulating layer 430 disposed between the outermost layer 410 and the pressure sensitive adhesive layer 10a-10b, a first copolymer bonding layer 420 disposed between and directly in contact with the outermost layer 410 and the aluminum insulating layer 430, and a second copolymer bonding layer 440 disposed between and directly in contact with the aluminum insulating layer 430 and the pressure sensitive adhesive layer 10a-10b.

In some embodiments, the multilayer film 500 consists essentially of a polyethylene outermost layer 410, a pressure sensitive adhesive layer 10a-10b disposed opposite the outermost layer 410, an EVOH insulating layer 430 disposed between the outermost layer 410 and the pressure sensitive adhesive layer 10a-10b, a first polyolefin-based tie-layer resin bonding layer 420 disposed between and directly in contact with the outermost layer 410 and the EVOH insulating layer 430, a polyethylene inner layer 550 disposed between the EVOH insulating layer 430 and the pressure sensitive adhesive layer 10a-10b, and a second polyolefin-based tie-layer resin bonding layer 440 disposed between and directly in contact with the EVOH insulating layer 430 and the polyethylene inner layer 550.

In some embodiments, the multilayer film 500 consists essentially of a polyethylene outermost layer 410, a pressure sensitive adhesive layer 10a-10b disposed opposite the outermost layer 410, an aluminum insulating layer 430 disposed between the outermost layer 410 and the pressure sensitive adhesive layer 10a-10b, a first copolymer bonding layer 420 disposed between and directly in contact with the outermost layer 410 and the aluminum insulating layer 430, a polyethylene inner layer 550 disposed between the aluminum insulating layer 430 and the pressure sensitive adhesive layer 10a-10b, and a second copolymer bonding layer 440 disposed between and directly in contact with the aluminum insulating layer 430 and the polyethylene inner layer 550.

1: A paste tube dispenser including an outer surface, an inner surface disposed opposite the outer surface, and an outlet disposed at one end, the paste tube dispenser comprising:
a first pressure sensitive adhesive disposed on a first portion of the inner surface; and
a second pressure sensitive adhesive disposed on a second portion of the inner surface substantially opposite the first pressure sensitive adhesive,
wherein upon squeezing the first pressure sensitive adhesive into contact with the second pressure sensitive adhesive, the first portion of the inner surface and the second portion of the inner surface collapse together to form a collapsed portion of the paste tube dispenser.

2: The paste tube dispenser of claim 1, wherein the collapsed portion is configured to substantially prevent paste stored within the paste tube dispenser from passing beyond the collapsed portion.

3: The paste tube dispenser of claim 1, wherein the collapsed portion is reversibly collapsed after the first pressure sensitive adhesive and the second pressure sensitive adhesive are squeezed into contact with each other.

4: The paste tube dispenser of claim 1, further comprising:
a third pressure sensitive adhesive disposed on a third portion of the inner surface; and
a fourth pressure sensitive adhesive disposed on a fourth portion of the inner surface substantially opposite the third pressure sensitive adhesive,
wherein upon squeezing the third pressure sensitive adhesive into contact with the fourth pressure sensitive adhesive, the third portion of the inner surface and the fourth portion of the inner surface collapse together to form a second collapsed portion of the paste tube dispenser.

5: The paste tube dispenser of claim 4, wherein the second collapsed portion is configured to substantially prevent paste stored within the paste tube dispenser from passing beyond the second collapsed portion.

6: The paste tube dispenser of claim 4, wherein the second collapsed portion is reversibly collapsed after the third pressure sensitive adhesive and the fourth pressure sensitive adhesive are squeezed into contact with each other.

7: The paste tube dispenser of claim 4 further comprising:
a fifth pressure sensitive adhesive disposed on a fifth portion of the inner surface; and
a sixth pressure sensitive adhesive disposed on a sixth portion of the inner surface substantially opposite the fifth pressure sensitive adhesive,
wherein upon squeezing the fifth pressure sensitive adhesive into contact with the sixth pressure sensitive adhesive, the fifth portion of the inner surface and the sixth portion of the inner surface collapse together to form a third collapsed portion of the paste tube dispenser.

8: The paste tube dispenser of claim 7, wherein the third collapsed portion is configured to substantially prevent paste stored within the paste tube dispenser from passing beyond the third collapsed portion.

9: The paste tube dispenser of claim 7, wherein the third collapsed portion is reversibly collapsed after the fifth pressure sensitive adhesive and the sixth pressure sensitive adhesive are squeezed into contact with each other.

10: The paste tube dispenser of claim 1, wherein each pressure sensitive adhesive is independently selected from the group consisting of: hook-and-loop fastener (e.g., VELCRO fastener, mushroom-head/mushroom-hook fastener (e.g., 3M Dual-Lock fastener), mixed hook-and-loop fastener (e.g., Halco USA mixed hook-and-loop fastener tape), and a chemical-based pressure sensitive adhesive.

11: The paste tube dispenser of claim 1, wherein each pressure sensitive adhesive is oriented at an angle β relative to an axis α of the paste tube dispenser.

12-29. (canceled)
